(19) United States
(12) Patent Application Publication
(10) Pub. No.: US 2017/0173924 A1
(43) Pub. Date: Jun. 22, 2017

(54) WATERPROOF FLOORING

(71) Applicants: Tony Fang, Cheshire, CT (US); Joseph F. Massa, SR., Orange, CT (US); Joseph F. Massa, JR., Orange, CT (US)

(72) Inventors: Tony Fang, Cheshire, CT (US); Joseph F. Massa, SR., Orange, CT (US); Joseph F. Massa, JR., Orange, CT (US)

(21) Appl. No.: 15/380,527

(22) Filed: Dec. 15, 2016

Related U.S. Application Data
(60) Provisional application No. 62/269,378, filed on Dec. 18, 2015.

(51) Int. Cl. B32B 27/08; B32B 5/18; B32B 27/30; B32B 5/32; B32B 27/06; B32B 27/12; B32B 5/02; B32B 5/26

(52) U.S. Cl. CPC B32B 27/08; B32B 5/028; B32B 5/18; B32B 5/26; B32B 5/32; B32B 27/065; B32B 27/12; B32B 27/30; B32B 2255/10; B32B 2255/02; B32B 2255/102; B32B 2307/71; B32B 2307/7265; B32B 2419/04; B32B 2262/101

(57) ABSTRACT

A waterproof flooring comprising: a top layer UV coating; a wear layer located below the UV coating; a picture layer located below the wear layer; a vinyl stiffener layer located below the picture layer; a core layer located below the vinyl stiffener layer.

### CROSS-REFERENCES

This patent application claims the benefit of U.S. Provisional Patent Application No. 62/269,378 by inventors Tony Fang, Joseph F. Massa, Sr., and Joseph F. Massa, Jr. entitled “WATERPROOF FLOORING,” filed on Dec. 18, 2015, and which provisional application is fully incorporated by reference herein.

### TECHNICAL FIELD

The present invention relates to a waterproof flooring and more specifically to a waterproof flooring, which resists cupping, blistering, cracking and odor.

### BACKGROUND

Flooring may be installed in a variety of locations. Often, a waterproof flooring may be desired in various locations, including but not limited to basements, outdoor locations, locations near water. Currently, there is no known flooring that can be easily installed that is fully waterproof. There are some flooring that are called waterproof, but they often contain wood, bamboo, cork, which can lead to problems with the flooring when exposed to moisture, such as cupping, blistering, cracking, and odor. Further, the known flooring that is called waterproof generally does not have padding, thus the floors are hard and uncomfortable. However, known paddings are generally not waterproof, thus the so-called waterproof flooring generally do not have padding.

Therefore, there is a need for a flooring that is waterproof and that overcomes the above described and other disadvantages.

### SUMMARY OF THE INVENTION

The invention relates to a waterproof flooring comprising: a top layer UV coating; a wear layer located below the UV coating; a picture layer located below the wear layer; a vinyl stiffener layer located below the picture layer; a core layer located below the vinyl stiffener layer.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front perspective view of the disclosed waterproof flooring;

FIG. 2 is a top view of the disclosed waterproof flooring;

FIG. 3 is another front perspective view of the disclosed waterproof flooring;

FIG. 4 is a perspective view of the disclosed waterproof flooring;

FIG. 5 is a close up view of one corner of the disclosed waterproof flooring; and

FIG. 6 is a perspective view showing generally the various layers fanned out.

### DETAILED DESCRIPTION

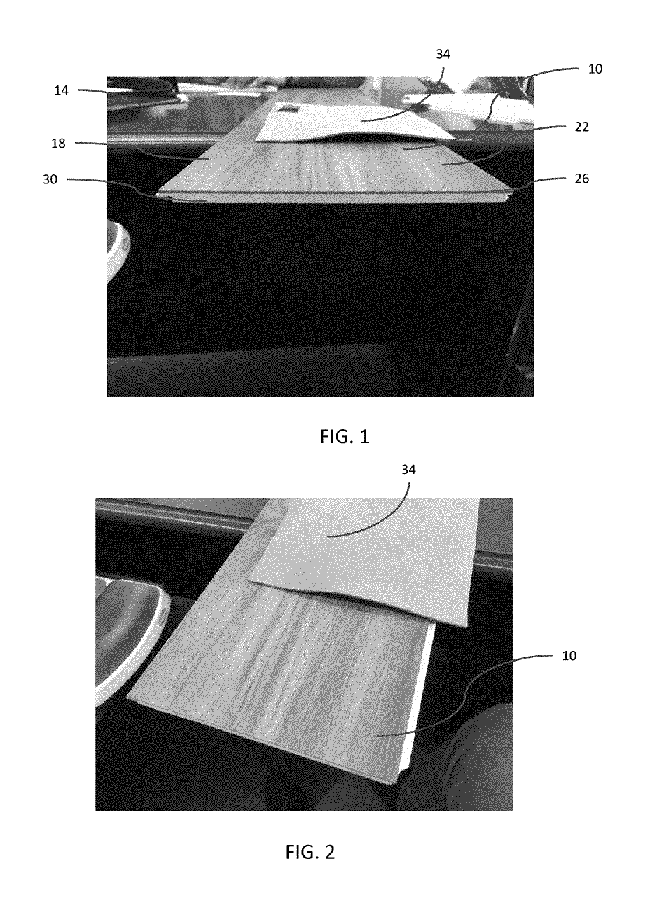

FIG. 1 shows a front perspective view of one embodiment of the waterproof flooring 10. The waterproof flooring comprises a top layer of UV coating 14, a wear layer 18, a picture layer 22, a vinyl stiffener layer 26, a core layer 30, and a padding 34. The padding 34 is shown on top of the flooring 10 before it is attached to the core layer 30. The padding 34 may be made out of any suitable waterproof material, including but not limited to rubber, vinyl, EVA, and EXPE. The layers may be attached to each other by any suitable attachment means, including but not limited to bonding with adhesive, heat pressed bonding, cold pressed bonding, and chemical bonding. The padding 34 will generally be attached to the core layer 30 prior to shipping to the end user. The padding 34 may be attached to the core layer 30 via adhesive, heat pressed bonding, cold pressed bonding, or chemical bonding. EVA, EXPE. The waterproof flooring may be made out of any suitable waterproof material, including but not limited to waterproof vinyl, virgin vinyl, EVA, EXPE, foam, and fiberglass mesh. In one embodiment, the wear layer 18, a picture layer 22, a vinyl stiffener layer 26, a core layer 30 may all be made out of waterproof vinyl.

FIG. 2 is a top view of the flooring 10 with the padding 34 laying on top of the flooring 10 prior to being attached to the core layer 30.

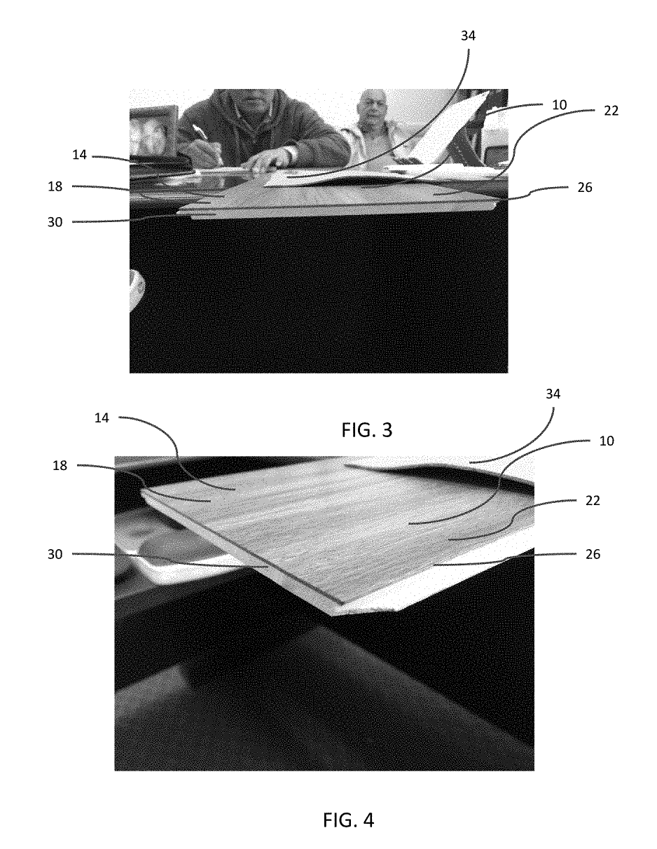

FIG. 3 is another front view of the flooring 10.

FIG. 4 is a perspective top view of the flooring 10.

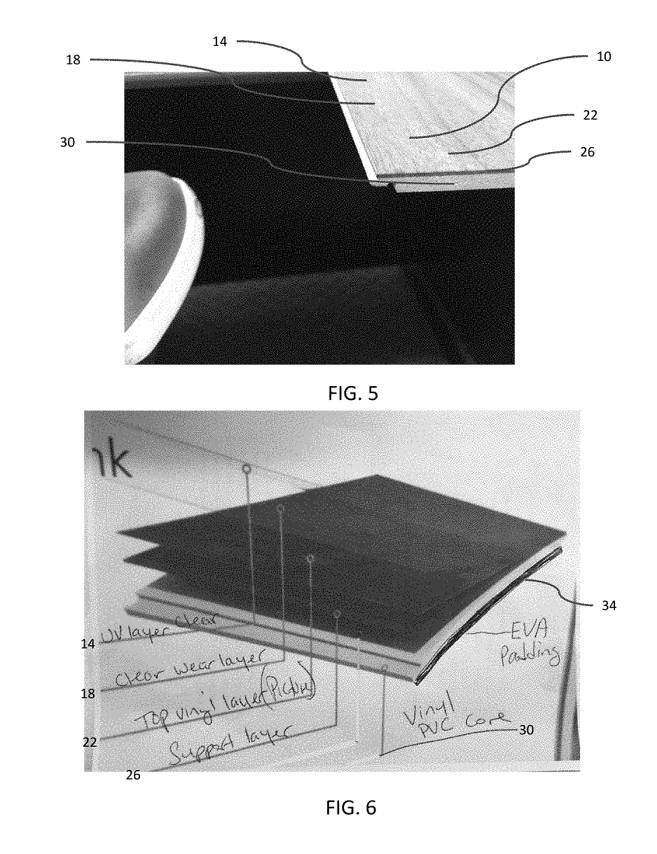

FIG. 5 is a close up corner view of the flooring 10.

FIG. 6 shows the flooring 10 with the various layers fanned out. The layers comprise: a top layer of UV coating 14, a wear layer 18, a picture layer 22, a vinyl stiffener layer 26, a core layer 30, and a padding 34. The padding layer in this embodiment may be an EVA padding, attached to the core layer 30.

The disclosed waterproof flooring has many advantages. The disclosed waterproof flooring may be made from 100% virgin vinyl, with a rubber padding attached to the core/underside of the flooring. The waterproof flooring can sit in water, and even be under water, with no water penetrating into the product. In one example, one can simply remove the water from the floor, dry the floor, and the disclosed waterproof flooring will be generally as good as new. When installing the disclosed waterproof flooring, there is no need to first lay out the padding on the ground, because the padding may already installed on the underside of the waterproof flooring in one embodiment.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A waterproof flooring comprising:
a top layer UV coating;
a wear layer located below the UV coating;
a picture layer located below the wear layer;
a vinyl stiffener layer located below the picture layer;
a core layer located below the vinyl stiffener layer.

2. The waterproof flooring of claim 1, further comprising:
a padding located below the core layer.

3. The waterproof flooring of claim 1, wherein each layer is a waterproof material.

4. The waterproof flooring of claim 1, wherein none of the layers contain any wood, bamboo, or cork.

5. The waterproof flooring of claim 2, wherein the padding is made out of a waterproof material.

6. The waterproof flooring of claim 2, wherein the padding is made out of a material selected from the group consisting of EVA and EXPE.

7. The waterproof flooring of claim 2, wherein the padding is configured to be placed below the core layer during a flooring installation process.

8. The waterproof flooring of claim 2, wherein the padding is attached to the underside of the core layer during the manufacturing of the waterproof flooring.

9. The waterproof flooring of claim 1, wherein:
the wear layer abuts the UV coating;
the picture layer abuts the wear layer;
the vinyl stiffener layer abuts the picture layer; and
the core layer abuts the vinyl stiffener layer.

10. The waterproof flooring of claim 9, wherein the padding abuts the core layer.

11. The waterproof flooring of claim 1, wherein:
the wear layer is permanently attached to the UV coating;
the picture layer is permanently attached to the wear layer;
the vinyl stiffener layer is permanently attached to the picture layer; and
the core layer is permanently attached to the vinyl stiffener layer.

12. The waterproof flooring of claim 11, wherein each layer is attached to an adjacent layer by a method selected from the group consisting of adhesive bonding, heat pressed bonding, cold pressed bonding, and chemical bonding.

13. The waterproof flooring of claim 11, wherein the padding is permanently attached to the core layer.

14. The waterproof flooring of claim 13, wherein the padding is attached to the core layer by a method selected from the group consisting of adhesive bonding, heat pressed bonding, cold pressed bonding, and chemical bonding.

15. The waterproof flooring of claim 1, wherein each layer is made out of waterproof vinyl.

16. The waterproof flooring of claim 1, wherein each layer may be made out of the material selected from the group consisting of waterproof vinyl, virgin vinyl, EVA, EXPE, foam, and fiberglass mesh
